(19) United States
(12) Patent Application Publication
(10) Pub. No.: US 2011/0305967 A1
(43) Pub. Date: Dec. 15, 2011

(54) FUEL CELL STACK

(76) Inventors: Chi-Seung Lee, Yongin-si (KR); Jin-Hwa Lee, Yongin-si (KR); Seong-Jin An, Yongin-si (KR)

(21) Appl. No.: 12/969,554

(22) Filed: Dec. 15, 2010

(30) Foreign Application Priority Data
Jun. 10, 2010 (KR) 10-2010-0054982

(51) Int. Cl. H01M 8/04; H01M 8/24

(52) U.S. Cl. 429/457

(57) ABSTRACT

A fuel cell stack including a plurality of membrane-electrode assemblies, a plurality of separators in close contact with the membrane-electrode assemblies between the membrane-electrode assemblies, and gaskets provided on the separators. Each of the separators includes an anode separator having first through holes and a cathode separator in contact with the anode separator and having the second through holes. Each of the gaskets includes a penetrating portion filled in the first through holes and penetrating the anode separator and the cathode separator and a sealing portion coupled to the penetrating portion and protruding from outer surfaces of the anode and cathode separators in a thickness direction of the anode separator and the cathode separator.

### CROSS-REFERENCE TO RELATED APPLICATION

This application claims priority to and the benefit of Korean Patent Application No. 10-2010-0054982, filed in the Korean Intellectual Property Office on Jun. 10, 2010, the entire content of which is incorporated herein by reference.

### BACKGROUND

(a) Field

The following description relates to a fuel cell stack. More particularly, the following description relates to a fuel cell stack that is provided with separators and gaskets.

(b) Description of Related Art

A fuel cell system includes a fuel cell stack generating electrical energy by an electrochemical reaction between a fuel (e.g., hydrocarbon fuel, pure hydrogen, or reformed gas rich in hydrogen) and an oxidant (e.g., air or pure oxygen). A direct oxidation fuel cell uses a liquid or gaseous hydrocarbon fuel, and a polymer electrode fuel cell uses pure hydrogen or a hydrogen-rich reformed gas as a fuel.

A fuel cell stack includes a plurality of membrane-electrode assemblies and a plurality of separators interposed between the membrane-electrode assemblies. Each separator functions to mechanically support the membrane-electrode assemblies and to electrically couple adjacent membrane-electrode assemblies. One membrane-electrode assembly and the separators located at both sides thereof constitute one unit cell.

The membrane-electrode assembly includes an electrolyte membrane, an anode on one side of the electrolyte membrane, and a cathode on the other side of the electrolyte membrane. The separator adjoining the anode has a fuel channel for supplying a fuel to the anode, and the separator adjoining the cathode has an oxidant channel for supplying an oxidant to the cathode.

A gasket is located between the membrane-electrode assembly and each of the separators to maintain air tightness between the membrane-electrode assembly and the separators. Accordingly, the fuel and oxidant supplied to the fuel cell stack do not leak out, and fluid leakage between fuel manifolds and oxidant manifolds formed in the separators can be prevented.

The gasket is formed by injection molding, and is located between the membrane-electrode assembly and the separators in a manufacturing process of the fuel cell stack. However, it is necessary to repeatedly stack a plurality of gaskets between a plurality of membrane-electrode assemblies and a plurality of separators in the mass production of a fuel cell stack, and this leads to the problem of low productivity and an increase in time required for production.

The above information disclosed in this Background section is only for enhancement of an understanding of the background of the invention, and therefore it may contain information that does not form the prior art that is already known in this country to a person of ordinary skill in the art.

### SUMMARY

Aspects of embodiments of the present invention are directed toward a separator and a fuel cell stack using the same, which can enhance productivity and reduce assembly time in a manufacturing process of a fuel cell stack by improving structures of its separator and its gasket.

An exemplary embodiment of the present invention provides a fuel cell stack including a plurality of membrane-electrode assemblies, a plurality of separators between the membrane-electrode assemblies and in contact with the membrane-electrode assemblies, and gaskets on the separators, wherein each of the separators includes an anode separator having first through holes, and a cathode separator in contact with the anode separator and having second through holes, and wherein each of the gaskets includes a penetrating portion filled in the first through holes and the second through holes and penetrating the anode separator and the cathode separator, and a sealing portion coupled to the penetrating portion and protruding from outer surfaces of the anode separator and the cathode separator in a thickness direction of the anode separator and the cathode separator.

The sealing portion may include an anode sealing portion on the outer surface of the anode separator, and a cathode sealing portion on the outer surface of the cathode separator, wherein the penetrating portion, the anode sealing portion, and the cathode sealing portion may be formed integrally with each other.

The penetrating portion and the anode and cathode sealing portions may be formed integrally with each other by a liquid rubber injection method.

The first through holes and the second through holes may have a same size in corresponding positions.

The anode sealing portion may have a greater width than at least one of that of the first through holes, and the cathode sealing portion may have a greater width than at least one of that of the second through holes.

The anode separator may have a fuel channel in an effective area of the outer surface of the anode separator, and the cathode separator may have an oxidant channel in an effective area of the outer surface of the cathode separator, and the first through holes and the second through holes may be positioned along peripheries of the effective areas outside the effective areas.

The anode sealing portion and the cathode sealing portion may each be formed in a closed curve enclosing the respective effective areas while covering the first and second through holes, respectively.

The anode separator and the cathode separator may have fuel manifolds and oxidant manifolds outside the effective areas, and the first through holes and the second through holes may be positioned along peripheries of the fuel manifolds and peripheries of the oxidant manifolds.

The anode sealing portion and the cathode sealing portion may each be formed in a closed curve enclosing the fuel manifolds and the oxidant manifolds while covering the first and second through holes, respectively.

The anode sealing portion and the cathode sealing portion may each have a shape including a first closed curve for enclosing the fuel manifolds and the oxidant manifolds, and a second closed curve bounding the first closed curve and for enclosing the respective effective areas, the second closed curve being larger than that of the first closed curve.

A bottom surface of the anode sealing portion may be in surface contact with the outer surface of the anode separator, and a bottom surface of the cathode sealing portion may be in surface contact with the outer surface of the cathode separator.

The anode separator may have a fuel connecting channel on an inner surface thereof for coupling the fuel manifolds and the fuel channel, and the cathode separator may have an oxidant connecting channel on an inner surface thereof for coupling the oxidant manifolds and the oxidant channel.

The anode separator and the cathode separator may have one or more cooling channels on inner surfaces thereof contacting each other.

The anode separator and the cathode separator may be assembled with a corresponding gasket of the gaskets and are arranged so as not to be misaligned with each other.

According to an exemplary embodiment of the present invention, the step of stacking a gasket between a membrane-electrode assembly and a separator can be omitted in the process of manufacturing a fuel cell stack by forming the gasket integrally with the separator. That is, the fuel cell stack can be assembled with only the process of stacking a separator formed integrally with a gasket between membrane-electrode assemblies. Consequently, it is possible to improve productivity and reduce assembly time in the process of manufacturing a fuel cell stack.

### BRIEF DESCRIPTION OF THE DRAWINGS

FIG. 1 is an exploded perspective view of a fuel cell stack according to one exemplary embodiment of the present invention.

FIG. 2 is an exploded perspective view showing one membrane-electrode assembly and two separators of the fuel cell stack of the one exemplary embodiment shown in FIG. 1.

FIG. 3 is a cross-sectional view of the one membrane-electrode assembly of the fuel cell stack of the one exemplary embodiment shown in FIG. 1.

FIG. 4 is an exploded perspective view of one of the separators and one of the gaskets of the fuel cell stack of the one exemplary embodiment shown in FIG. 2.

FIG. 5A is a cross-sectional view taken along line I-I of FIG. 2.

FIG. 5B is a cross-sectional view taken along line II-II of FIG. 2.

FIG. 5C is a cross-sectional view taken along line of FIG. 2.

FIGS. 6 and 7 are schematic views shown to explain a manufacturing method of a gasket of a fuel cell stack of an exemplary embodiment of the present invention, and are a cross-sectional view of a separator taken along line III-III of FIG. 2.

### DETAILED DESCRIPTION

Embodiments of the present invention will be described more fully hereinafter with reference to the accompanying drawings, in which exemplary embodiments of the present invention are shown. As those skilled in the art will realize, the described embodiments may be modified in various different ways, all without departing from the spirit or scope of the present invention.

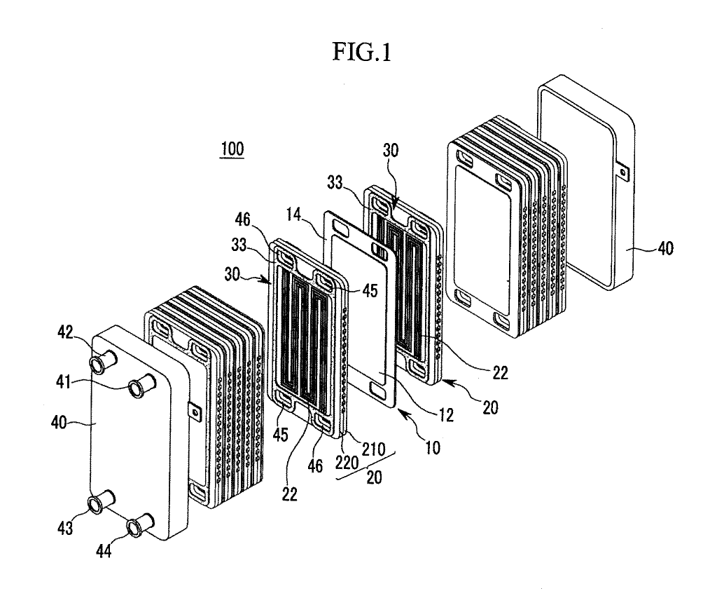

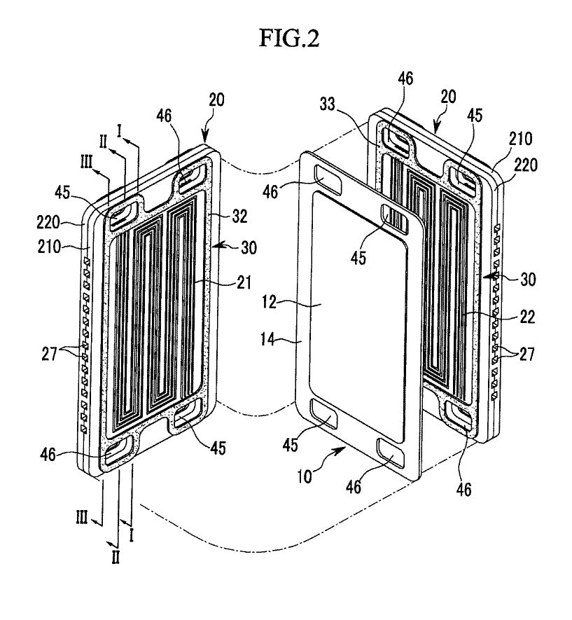

FIG. 1 is an exploded perspective view of a fuel cell stack according to one exemplary embodiment of the present invention, and FIG. 2 is an exploded perspective view showing one membrane-electrode assembly and two separators of the fuel cell stack of the one exemplary embodiment shown in FIG. 1.

Referring to FIGS. 1 and 2, the fuel cell stack 100 of the present exemplary embodiment includes a plurality of membrane-electrode assemblies 10, a plurality of separators 20 in close contact with, and between, the membrane-electrode assemblies 10, and gaskets 30 formed (e.g., integrally formed) with the separators 20. One membrane-electrode assembly 10 and two separators 20 positioned on both sides thereof constitute one unit cell that generates electrical energy.

The membrane-electrode assembly 10 is supplied with a fuel and an oxidant, and generates electrical energy by an electrochemical reaction of the fuel and the oxidant. Each of the separators 20 has a fuel channel 21 formed to adjoin one side of the membrane-electrode assembly 10, and an oxidant channel 22 formed to adjoin the other side of the membrane-electrode assembly 10, to thus supply a fuel and an oxidant to the membrane-electrode assembly 10. The separators 20 support the membrane-electrode assemblies 10 by pressing the membrane-electrode assemblies 10 having low mechanical strength (e.g., low rigidity), and electrically couple the membrane-electrode assemblies 10.

The fuel cell stack 100 may adopt a direct oxidation fuel cell scheme, and may use liquid and/or gaseous hydrocarbon fuels (e.g., methanol, ethanol, liquefied petroleum gas, liquefied natural gas, gasoline, and/or butane gas). Alternatively, the fuel cell stack 100 may adopt a polymer electrolyte membrane fuel cell scheme, and may use hydrogen or a hydrogen-rich gas generated by cracking a liquid or gaseous hydrocarbon fuel in a reformer as a fuel. The fuel cell stack 100 may use pure oxygen stored in a separate storage member, or oxygen-containing air (e.g., unreformed air), as an oxidant.

A pair of end plates 40 for integrally fixing the fuel cell stack 100 are provided on the outermost sides of the fuel cell stack 100. Either one of the end plates 40 may be provided with a fuel injection port 41 for supplying a fuel to the fuel cell stack 100, an oxidant injection port 42 for supplying an oxidant, a fuel exhaust port 43 for exhausting unreacted fuel, and an oxidant exhaust port 44 for exhausting moisture and unreacted air.

Although FIG. 1 illustrates that one end plate 40 has two injection ports 41 and 42 and two exhaust ports 43 and 44, other arrangements of the ports 41, 42, 43, and 44 are within the scope of the invention. For example, either one of the end plates 40 may have a fuel injection port 41 and an oxidant injection port 42, and the other end plate 40 may have a fuel exhaust port 43 and an oxidant exhaust port 44.

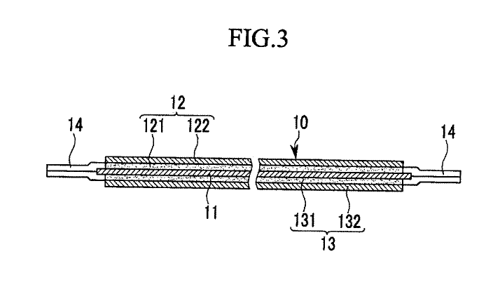

FIG. 3 is a cross-sectional view of the membrane-electrode assembly of the fuel cell stack of the one embodiment shown in FIG. 1.

Referring to FIG. 3, the membrane-electrode assembly 10 includes an electrolyte membrane 11, an anode 12 formed on one surface of the electrolyte membrane 11, a cathode 13 formed on the other surface of the electrolyte membrane 11, and a support film 14 secured to a periphery of the electrolyte membrane 11.

The anode 12 is supplied with a fuel, and includes a catalyst layer 121 for converting hydrogen in the fuel into electrons and hydrogen ions by an oxidation reaction, and a gas diffusion layer 122 covering the catalyst layer 121. The cathode 13 is supplied with an oxidant, and includes a catalyst layer 131 for converting oxygen in the oxidant into electrons and oxygen ions by a reduction reaction, and a gas diffusion layer 132 covering the catalyst layer 131. The electrolyte membrane 11 has an ion exchange function to transfer hydrogen ions generated in the catalyst layer 121 of the anode 12 to the catalyst layer 131 of the cathode 13.

The areas of the anode 12 and the cathode 13 are smaller than that of the electrolyte membrane 11, and the support film 14 is secured to the periphery of the electrolyte membrane 11 where the anode 12 and the cathode 13 are not formed. The support film 14 suppresses the expansion and contraction of the electrolyte membrane 11 due to moisture absorption, and enables the electrolyte membrane 11 to be mechanically fastened to the separators 20. The support film 14 is provided with fuel manifolds 45 (see FIG. 2) for passing a fuel therethrough, and oxidant manifolds 46 (see FIG. 2) for passing an oxidant therethrough.

A thickness of the periphery of the membrane-electrode assembly 10 where the support film 14 is located is smaller than a thickness of a center of the membrane-electrode assembly 10 where the anode 12 and the cathode 13 are formed.

Referring again to FIGS. 1 and 2, each of the separators 20 between two membrane-electrode assemblies 10 may be divided into an anode separator 210 facing the anode 12 and a cathode separator 220 facing the cathode 13. The anode separator 210 and the cathode separator 220 are each provided with two fuel manifolds 45 and two oxidant manifolds 46.

The fuel channel 21 is located in an effective area of the outer surface of the anode separator 210, and is coupled to the two fuel manifolds 45 positioned outside the effective area. The oxidant channel 22 is located in an effective area of the outer surface of the cathode separator 220, and is coupled to the two oxidant manifolds 46 positioned outside the effective area. Here, the effective areas are defined as areas of the membrane-electrode assembly 10 where the anode 12 and the cathode 13 are formed, respectively. The support film 14 is also positioned outside the effective areas.

The fuel supplied to the fuel injection port 41 is distributed to the fuel channels 21 of the anode separators 210 through one of the fuel manifolds 45 coupled to the fuel injection port 41, and is supplied (e.g., simultaneously supplied) to the anodes 12 of the membrane-electrode assemblies 10. The oxidant supplied to the oxidant injection port 42 is distributed to the oxidant channels 22 of the cathode separators 220 through one of the oxidant manifolds 46 coupled to the oxidant injection port 42, and is supplied (e.g., simultaneously supplied) to the cathodes 13 of the membrane-electrode assemblies 10. Accordingly, electrical energy is generated by an electrochemical reaction between the fuel and the oxidant in the membrane-electrode assemblies 10.

An amount of unreacted fuel not used for the electrochemical reaction of the membrane-electrode assemblies 10 passes through the fuel manifolds 45 on the opposite side, and is exhausted out of the fuel cell stack 100 via the fuel exhaust port 43. An amount of unreacted oxidant not used for the electrochemical reaction of the membrane-electrode assemblies 10, along with moisture generated as a by-product of the electrochemical reaction of the membrane-electrode assemblies 10, pass through the oxidant manifolds 46 on the opposite side and are exhausted out of the fuel cell stack 100 via the oxidant exhaust port 44.

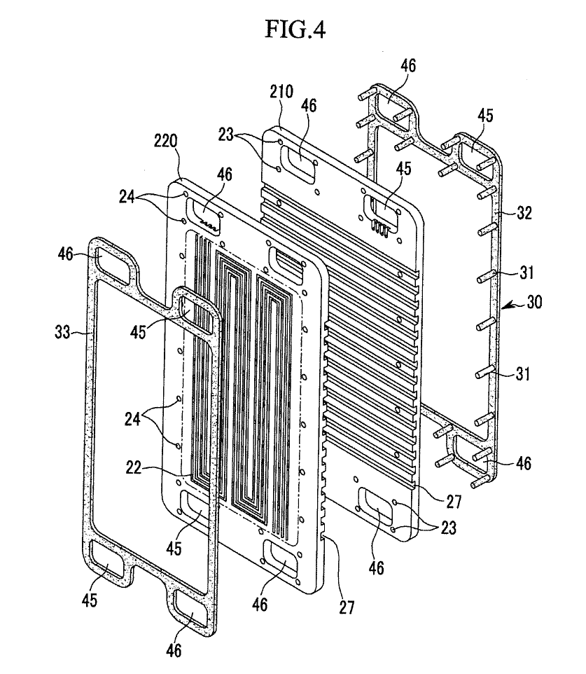

The gasket 30 penetrates (e.g., with one or more penetrating portions 31, see FIG. 4) the anode separator 210 and the cathode separator 220, and is formed (e.g., integrally formed) with the two separators 210 and 220. Therefore, the anode separator 210 and the cathode separator 220 may be preassembled with the gasket 30 and aligned with each other, instead of being integrally bonded to each other with an adhesive such as a conductive resin. The gasket 30 may be formed of rubber, such as fluorine rubber, silicon rubber, or ethylene propylene rubber, and has elasticity (e.g., predetermined elasticity).

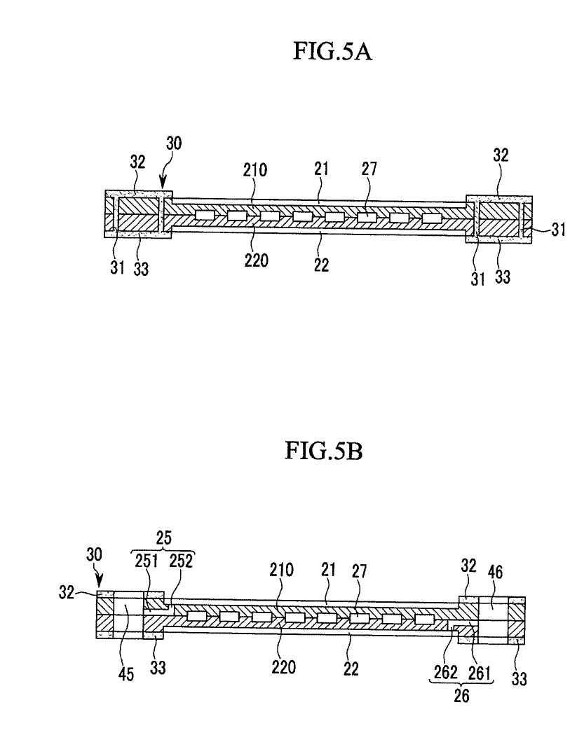

FIG. 4 is an exploded perspective view of the separator and the gasket of the fuel cell stack 100 of the one exemplary embodiment shown in FIG. 2, and FIGS. 5A to 5C are cross-sectional views taken along line I-I, line II-II, and line III-III of FIG. 2.

Referring to FIGS. 4 to 5C, the anode separator 210 and the cathode separator 220 respectively have a plurality of through holes 23 and 24 positioned at a distance from each other along the peripheries of the effective areas outside the effective areas (indicated by a dashed line), and a plurality of through holes 23 and 24 positioned outside the fuel manifolds 45 and the oxidant manifolds 46, respectively. In one embodiment, the first through holes 23 of the anode separator 210 and the second through holes 24 of the cathode separator 220 are formed with the same size at the same positions.

The positions, number, size, and shape of the first through holes 23 and the second through holes 24 formed on the two separators 210 and 220 are not limited to the one exemplary embodiment shown in FIG. 4, and may be varied in many suitable ways.

The gasket 30 includes a penetrating portion 31, an anode sealing portion 32, and a cathode sealing portion 33. The penetrating portion 31 is formed to fill the first through holes 23 and the second through holes 24, and penetrates the two separators 210 and 220. The anode sealing portion 32 is coupled to the penetrating portion 31 and protrudes from the outer surface of the anode separator 210 by a thickness (e.g., predetermined thickness). The cathode sealing portion 33 is coupled to the penetrating portion 31 and protrudes from the outer surface of the cathode separator 220 by a thickness (e.g., predetermined thickness). In one embodiment, the anode sealing portion 32 and cathode sealing portion 33 and the penetrating portion 31 are formed integrally with each other by a liquid rubber injection method to be explained later.

The anode sealing portion 32 is formed in (e.g., in the shape of) a large closed curve enclosing the fuel channel 21 on the outer surface of the anode separator 210, and four small closed curves enclosing the two fuel manifolds 45 and the two oxidant manifolds 46 are bounded by (e.g., formed with) the large closed curve. The anode sealing portion 32 has a thickness (e.g., predetermined thickness) and a width (e.g. predetermined width).

The cathode sealing portion 33 is formed in (e.g., in the shape of) a large closed curve enclosing the oxidant channel 22 on the outer surface of the cathode separator 220, and four small closed curves enclosing the two fuel manifolds 45 and the two oxidant manifolds 46 are bounded by (e.g., formed with) the large closed curve. The cathode sealing portion 33 has a thickness (e.g., predetermined thickness) and a width (e.g. predetermined width), and has the same, or a similar, shape as the anode sealing portion 32.

The anode sealing portion 32 and the cathode sealing portion 33 overlap the through holes 23 and 24, and are coupled to the penetrating portion 31 along the thickness direction of the separator 20. The widths of the anode sealing portion 32 and the cathode sealing portion 33 are greater than the diameter of the penetrating portion 31 (e.g., the individual members of the penetrating portion 31) (if the penetrating portion 31 is not circular, the width of the penetrating portion 31) and covers the entire penetrating portion 31 (e.g., each penetrating portion 31 or each part of the penetrating portion 31).

Accordingly, the anode sealing portion 32 and cathode sealing portion 33 of the gasket 30 enclose and seal the fuel channel 21, the oxidant channel 22, the fuel manifolds 45, and the oxidant manifolds 46. Moreover, the anode sealing portion 32 and the cathode sealing portion 33 may prevent the fuel flowing through the fuel manifolds 45 and the fuel channel 21 and the oxidant flowing through the oxidant manifolds 46 and the oxidant channel 22 from leaking out of the fuel cell stack 100.

The anode separator 210 and the cathode separator 220 have no groove for disposing the gasket 30 therein, and the anode sealing portion 32 and the cathode sealing portion 33 protrude by their respective thicknesses out of the anode separator 210 and the cathode separator 220, respectively. As a result, the anode sealing portion 32 and the cathode sealing portion 33 can be freely deformed (e.g., in a sideways direction) because they can spread sideways when pressure is applied along the thickness direction of the separator 20.

The gasket 30 receives pressure in the course of pressing the pair of end plates 40 (see FIG. 1) and joining them to the fuel cell stack 100. That is, when the plurality of membrane-electrode assemblies 10 and the plurality of separators 20 are located between the pair of end plates 40, and the pair of end plates 40 are pressed by fastening members, such as bolts, pressure is applied to the gaskets 30 along the thickness direction of the separators 20.

When the anode separator 210 and the cathode separator 220 have a groove for disposing the gasket 30 therein, and when excessive force is applied to the gasket mounted in the groove, the gasket 30 made of rubber may be deformed and come out of the groove. Then, a gap may be formed between the membrane-electrode assembly 10 and the separator 20, and therefore the fuel or oxidant may leak out because air tightness (e.g., an airtight seal) between the membrane-electrode assembly 10 and the separator 20 is not achieved.

However, in the fuel cell stack of the described exemplary embodiment, the anode sealing portion 32 and the cathode sealing portion 33 are not mounted on, or within, a groove, but protrude out of the separator 20 so they can spread freely sideways when they are deformed by pressure, thereby maintaining air tightness between the membrane-electrode assembly 10 and the separator 20.

Moreover, the entire bottom surface of the anode sealing portion 32 may be in surface contact with the anode separator 210, and the entire bottom surface of the cathode sealing portion 33 may be in surface contact with the cathode separator 220. That is, the anode separator 210 and the cathode separator 220 may lack a groove in areas contacting the anode sealing portion 32 and the cathode sealing portion 33.

To this end, the fuel manifolds 45 and the fuel channel 21 may be coupled by a fuel connecting channel 25 (see FIG. 5b) formed on the inner surface of the anode separator 210, and the oxidant manifolds 46 and the oxidant channel 22 may be coupled by an oxidant connecting channel 26 (see FIG. 5b) formed on the inner surface of the cathode separator 220. The connecting channels 25 and 26 consist of horizontal portions 251 and 261 extending from the fuel manifolds 45 or the oxidant manifolds 46 toward the effective area, and vertical portions 252 and 262 extending along the thickness direction of the two separators 210 and 220 from the horizontal portions 251 and 261 and communicating with the fuel channel 21 and the oxidant channel 22, respectively.

Therefore, the anode separator 210 and the cathode separator 220 can improve the airtight effect of the gasket 30 as the two separators 210 and 220 and the gasket 30 are brought into close contact with each other by forming flat surfaces between the effective area and the fuel manifolds 45 and between the effective area and the oxidant manifolds 46.

Meanwhile, a cooling channel 27 may be formed on the inner surface of the anode separator 210 and the inner surface of the cathode separator 220 (e.g., a first half of the cooling channel 27 is formed on inner surface of the anode separator 210, a second half of the cooling channel 27 is formed on the inner surface of the cathode separator 220, and the two halves thereby form the cooling channel 27 when the anode separator 210 and the cathode separator 220 are aligned). The cooling channel 27 is coupled to a blowing unit, and outside air enters the cooling channel 27 by force (e.g., suction force) of the blowing unit. Therefore, the temperature of the fuel cell stack 100 can be lowered by heat exchange between the outside air and the fuel cell stack 100.

Next, a manufacturing method of the gasket 30 will be described.

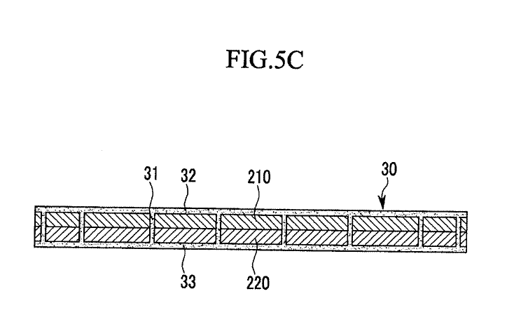

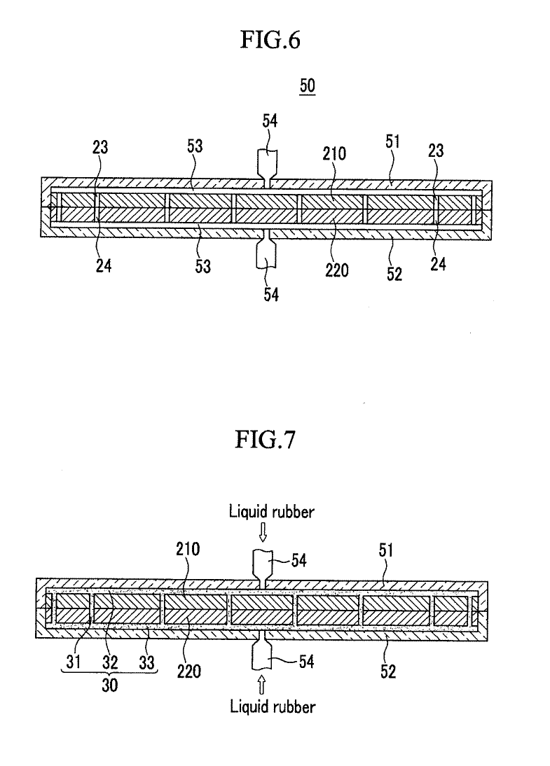

FIGS. 6 and 7 are schematic views shown to explain a manufacturing method of a gasket of an embodiment of the present invention. FIGS. 6 and 7 show cross-sections of the separator taken along line III-III of FIG. 2.

Referring to FIG. 6, the anode separator 210 and cathode separator 220 having the plurality of through holes 23 and 24 are prepared, and the two separators 210 and 220 are stacked and then installed within a gasket insertion apparatus 50. The gasket insertion apparatus 50 includes an upper support body 51 and a lower support body 52, and recessed flow paths 53, which correspond to the shapes of the anode sealing portion 32 and cathode sealing portion 33, are formed within the upper support body 51 and the lower support body 52. The flow paths 53 are coupled to gasket injection nozzles 54 installed at the upper support body 51 and the lower support body 52.

Referring to FIG. 7, liquid rubber is injected into the flow path of the upper support body 51 and the flow path 53 of the lower support body 52 through the gasket injection nozzles 54. The liquid rubber may be any one of, for example, liquid fluorine rubber, liquid silicon rubber, and liquid ethylene propylene rubber. Accordingly, the liquid rubber is filled in the flow path 53 of the upper support body 51, the flow path 53 of the lower support body 52, and the through holes 23 and 24 formed in the two separators 210 and 220. The filled liquid rubber is cured, thereby completing the gasket 30.

The anode separator 210 and the cathode separator 220 are preassembled with the gasket 30, and are arranged to be aligned (e.g., so as to not be misaligned with each other). That is, while the two separators 210 and 220 are conventionally bonded together by an adhesive, such as a conductive resin, the separator 20 of this exemplary embodiment is assembled by the gasket 30 without bonding the anode separator 210 and the cathode separator 220 together, while maintaining its aligned state only to such a degree to prevent misalignment.

After that, the two separators 210 and 220 are brought into close contact with each other by pressure generated by pressing the pair of end plates 40, and are firmly assembled. The anode sealing portion 32 and cathode sealing portion 33 of the gasket 30 also receive pressure and are deformed (e.g., pressed) to reduce their thickness. Such deformation of the gasket 30 enables the anode 12 of the membrane-electrode assembly 10 to be in close contact with the fuel channel 21, and enables the cathode electrode 13 thereof to be in close contact with the oxidant channel 22.

As such, the step of stacking a gasket 30 between a membrane-electrode assembly 10 and a separator 20 can be omitted in the process of manufacturing a fuel cell stack 100 by forming the gasket 30 integrally with the separator 20. That is, a fuel cell stack 100 may be assembled by only the process of stacking a separator 20 formed integrally with a gasket 30 between membrane-electrode assemblies 10. Consequently, it is possible to improve productivity and reduce assembly time in the process of manufacturing the fuel cell stack 100. However, it should be understood that a gasket of embodiments of the present invention may be manufactured through different methods, and the present invention is therefore not limited to the aforementioned manufacturing method.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Description of some of the reference characters of the drawings

| | |
|---|---|
| 100: fuel cell stack | 10: membrane-electrode assembly |
| 20: separator | 30: gasket |
| 40: end plate | 210: anode separator |
| 220: cathode separator | 23, 24: through hole |
| 31: penetrating portion | 32: anode sealing portion |
| 33: cathode sealing portion | |

What is claimed is:

1. A fuel cell stack comprising:
a plurality of membrane-electrode assemblies;
a plurality of separators between the membrane-electrode assemblies and in contact with the membrane-electrode assemblies; and
gaskets on the separators, wherein each of the separators comprises:
an anode separator having first through holes; and
a cathode separator in contact with the anode separator and having second through holes,
and wherein each of the gaskets comprises:
a penetrating portion filled in the first through holes and the second through holes and penetrating the anode separator and the cathode separator; and
a sealing portion coupled to the penetrating portion and protruding from outer surfaces of the anode separator and the cathode separator in a thickness direction of the anode separator and the cathode separator.

2. The fuel cell stack of claim 1, wherein the sealing portion comprises:
an anode sealing portion on the outer surface of the anode separator; and
a cathode sealing portion on the outer surface of the cathode separator, wherein the penetrating portion, the anode sealing portion, and the cathode sealing portion are formed integrally with each other.

3. The fuel cell stack of claim 2, wherein the penetrating portion and the anode and cathode sealing portions are formed integrally with each other by a liquid rubber injection method.

4. The fuel cell stack of claim 2, wherein the first through holes and the second through holes have a same size in corresponding positions.

5. The fuel cell stack of claim 4, wherein the anode sealing portion has a greater width than that of at least one of the first through holes, and the cathode sealing portion has a greater width than that of at least one of the second through holes.

6. The fuel cell stack of claim 2, wherein the anode separator has a fuel channel in an effective area of the outer surface of the anode separator, and the cathode separator has an oxidant channel in an effective area of the outer surface of the cathode separator, and the first through holes and the second through holes are positioned along peripheries of the effective areas outside the effective areas.

7. The fuel cell stack of claim 6, wherein the anode sealing portion and the cathode sealing portion are each formed in a closed curve enclosing the respective effective areas while covering the first and second through holes, respectively.

8. The fuel cell stack of claim 6, wherein the anode separator and the cathode separator have fuel manifolds and oxidant manifolds outside the effective areas, and the first through holes and the second through holes are positioned along peripheries of the fuel manifolds and peripheries of the oxidant manifolds.

9. The fuel cell stack of claim 8, wherein the anode sealing portion and the cathode sealing portion are each formed in a closed curve enclosing the fuel manifolds and the oxidant manifolds while covering the first and second through holes, respectively.

10. The fuel cell stack of claim 8, wherein the anode sealing portion and the cathode sealing portion each have a shape comprising a first closed curve for enclosing the fuel manifolds and the oxidant manifolds, and a second closed curve bounding the first closed curve and for enclosing the respective effective areas, the second closed curve being larger than that of the first closed curve.

11. The fuel cell stack of claim 8, wherein a bottom surface of the anode sealing portion is in surface contact with the outer surface of the anode separator, and a bottom surface of the cathode sealing portion is in surface contact with the outer surface of the cathode separator.

12. The fuel cell stack of claim 11, wherein the anode separator has a fuel connecting channel on an inner surface thereof for coupling the fuel manifolds and the fuel channel, and the cathode separator has an oxidant connecting channel on an inner surface thereof for coupling the oxidant manifolds and the oxidant channel.

13. The fuel cell stack of claim 1, wherein the anode separator and the cathode separator have one or more cooling channels on inner surfaces thereof contacting each other.

14. The fuel cell stack of claim 1, wherein the anode separator and the cathode separator are assembled with a corresponding gasket of the gaskets and are arranged so as not to be misaligned with each other.
